(19) United States
(12) Patent Application Publication
(10) Pub. No.: US 2019/0393782 A1
(43) Pub. Date: Dec. 26, 2019

(54) COMBINED INDUCTIVE AND SWITCHED CAPACITIVE POWER SUPPLY CONVERSION

(71) Applicants: Mykhaylo Teplechuk, San Diego, CA (US); Taner Dosluoglu, New York, NY (US)

(72) Inventors: Mykhaylo Teplechuk, San Diego, CA (US); Taner Dosluoglu, New York, NY (US)

(21) Appl. No.: 16/451,529

(22) Filed: Jun. 25, 2019

Related U.S. Application Data
(63) Continuation of application No. 62/689,613, filed on Jun. 25, 2018.

(51) Int. Cl. H02M 3/156; H02M 3/06; G05F 1/52

(52) U.S. Cl. CPC H02M 3/156; G05F 1/52; H02M 3/06

(57) ABSTRACT

A DC-DC switching converter with an LC output filter has a switched capacitor converter providing the capacitance of the output filter. The switched capacitor converter may be a multi-phase switched capacitor converter. Topology of connections between capacitors of the multi-phase switched capacitor converter may be dependent on phases of clock signal(s) provided to the multi-phase switched capacitor converter. The switched capacitor converter may rely on parasitic inductances, or include discrete inductors, in series between connected capacitors to allow for adiabatic or near adiabatic voltage conversion.

### CROSS REFERENCE TO RELATED APPLICATION

This application claims the benefit of the filing date of U.S. Provisional Patent Application No. 62/689,613, filed on Jun. 25, 2018, the disclosure of which is incorporated by reference herein.

### BACKGROUND OF THE INVENTION

The present invention relates generally to power management for semiconductor devices, and more particularly to use of switched capacitor converters in semiconductor power management devices.

Integrated circuits generally require provision of power within particular parameters during operation. The provision of such power may face many complexities. For example, semiconductor chips including the integrated circuits may have different portions that require power at the same or different times, different portions may require power within different parameters, and some portions may utilize different amounts of power at different times. This may be particularly true for those chips integrating multiple components that may be considered a system-on-chip (SOC). Complicating matters, some devices may be powered by batteries having relatively small capacities, while the devices themselves, at least at various times, may require large amounts of power.

Further complicating matters, while battery technology may remain relatively unchanged for mobile devices and the like, typically supplying voltage in the 2.8V-4.5V range for example, supply voltage levels for operation of the integrated circuits of SOCs has generally been steadily reducing. Similarly, while servers and industrial applications may make use of new SOCs, legacy rack supply voltage arrangements, typically 12V, generally remain unchanged. Provision of power at voltage levels significantly lower than supply voltage levels may result in increased power losses as the voltage level is stepped down.

### BRIEF SUMMARY OF THE INVENTION

In some aspects a DC-DC switching converter with an LC output filter has a switched capacitor converter providing the capacitance of the output filter. In some aspects a DC-DC switching converter has a switched capacitor converter in place of an output capacitor. In some aspects the switched capacitor converter is a multi-phase switched capacitor converter. In some embodiments topology of connections between capacitors of the multi-phase switched capacitor converter is dependent on phases of clock signal(s) provided to the multi-phase switched capacitor converter. In some embodiments the multi-phase switched capacitor converter comprises multiple instantiations of a switched capacitor converter, each provided a single clock signal or multiple clock signals having different phase relationships.

In some aspects a DC-DC switching converter in a buck configuration has a multi-phase switched capacitor converter in place of an output capacitor. In some embodiments the multi-phase switched capacitor converter has at least one capacitor coupled at all times between an output to a load and a lower voltage node, for example a ground node.

In some embodiments switching of the switched capacitor converter is performed at a rate sufficient that voltage difference between connected capacitors of the switched capacitor converter may be stored in parasitic inductances of the switched capacitor converter during switching operations. In some embodiments the switched capacitor converter includes discrete inductors coupled in series between the capacitors. In some embodiments the switched capacitor converter performs adiabatic power conversion.

In some embodiments a further power converter is provided between the output to the load and the load. In some embodiments the further power converter is a further DC-DC switching converter. In some embodiments the further DC-DC switching converter has a buck converter topology. In some embodiments the further power converter is a linear dropout (LDO) regulator.

Some embodiments in accordance with aspects of the invention provide a DC-DC converter, comprising: a high side switch and a low side switch coupled in series between an input voltage and a lower voltage; and an LC filter coupled to a node between the high side switch and the low side switch, the LC filter comprising an inductor and a capacitance, with a first end of the inductor coupled to the node between the high side switch and the low side switch and a second end of the inductor coupled to the capacitance, the capacitance essentially consisting a switched capacitor converter.

Some embodiments in accordance with aspects of the invention provide a DC-DC converter, comprising: an inductive power conversion stage comprising a high side switch and a low side switch, coupled in series between an input voltage and a lower voltage, and an inductor having a first end coupled to a node between the high side switch and the low side switch; a switched capacitor converter coupled between a second end of the inductor and the lower voltage, the switched capacitor converter comprising a plurality of capacitor and a plurality of switches, the switches operable to have the switched capacitor converter downconvert a voltage provided at the second end of the inductor by a fixed ratio, the switched capacitor converter including sufficient inductances to allow for transfer of charge during switching without non-adiabatic loss.

These and other aspects of the invention are more fully comprehended upon review of this disclosure.

### BRIEF DESCRIPTION OF THE FIGURES

FIG. 1 is a semi-schematic, semi-block diagram including voltage regulator circuitry in accordance with aspects of the invention.

FIG. 2 is a chart illustrating example operation of the voltage regulator of FIG. 1.

FIG. 3 is a semi-schematic, semi-block diagram including further voltage regulator circuitry in accordance with aspects of the invention.

FIG. 4 is a chart illustrating operation of the voltage regulator of FIG. 3.

FIG. 5 is a semi-schematic, semi-block diagram including a still further voltage regulator circuitry in accordance with aspects of the invention.

FIG. 6A is a semi-schematic of an example multi-phase switched capacitor converter in accordance with some aspects of the invention.

FIG. 6B is a semi-schematic of a further example multi-phase switched capacitor converter in accordance with some aspects of the invention.

FIG. 7 is a semi-schematic of an example multi-phase switched capacitor converter illustrating inductances associated with each of the capacitors in accordance with some aspects of the invention.

FIG. 8 is a graph illustrating non-adiabatic charge transfer between capacitors of a switched capacitor converter, for example the switched capacitor converter of FIG. 6.

FIG. 9 is a similar graph illustrating adiabatic charge transfer between capacitors of a switched capacitor converter utilizing series inductance, for example the switched capacitor converter of FIG. 7.

FIG. 10 is a graph showing increases in efficiency between adiabatic operation and non-adiabatic operation for different voltage differences between capacitors.

### DETAILED DESCRIPTION

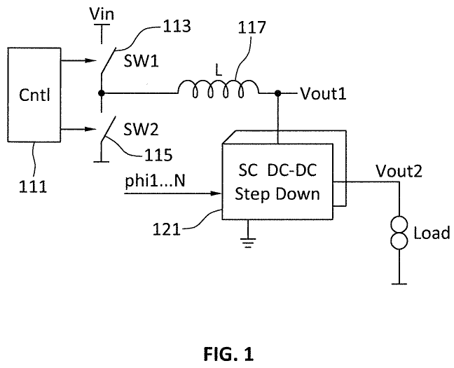

FIG. 1 is a semi-schematic, semi-block diagram including voltage regulator circuitry in accordance with aspects of the invention. As shown in FIG. 1, a pair of switches, a high side switch 113 and a low side switch 115, are coupled in series between an input voltage and a lower voltage. In many embodiments the input voltage is a supply voltage, for example provided by a battery, and in some embodiments the lower voltage is ground. A first end of an inductor 117 is coupled to a node between the high side switch and the low side switch. A second end of the inductor is coupled by way of a DC-DC switched capacitor step down converter 121 to ground. An output from the DC-DC switched capacitor step down converter, which may be referred to simply as a switched capacitor converter, provides power to a load. Generally, the switched capacitor converter always includes at least one capacitor coupled between the output to the load and ground (or some other lower voltage, for example the lower voltage to which the low side switch is coupled).

In the embodiment of FIG. 1, the switched capacitor converter is a multiphase switched capacitor converter. In some embodiments topology of the capacitors of the switched capacitor converter is determined by multiple phases of a clock signal. In some embodiments multiple instantiations of the switched capacitor converter are used, which may be driven by a single phase clock signal or a multi-phase clock signal.

In some embodiments the circuitry of FIG. 1 may be considered to generally be in the form of a buck converter topology, with the multi-phase switched capacitor converter in place of an output capacitor normally used in such an architecture. In various embodiments the switched capacitor converter always has at least one capacitor coupled between the output provided to the load, and in such embodiments the circuitry of FIG. 1 may be considered to generally be in the form of a buck converter topology, with a multi-phase switched capacitor converter in place of an output capacitor normally used in such an architecture.

The high side switch and the low side switch are generally controlled in a synchronous manner, with only one of the high side switch or low side switch closed at any instant of time, by control circuitry 111. The control circuitry generally controls the switches based on various feedback signals, which may include some or all of for example a signal indicative of inductor current, a signal indicative of voltage at a node between the inductor and the switched capacitor converter, a signal indicative of voltage provided to the load, and various other signals.

In some embodiments the switches and inductor provide an inductive down conversion stage, and provides a finely adjustable step down ratio N, with for example the inductive down conversion stage having the switches operated using pulse width modulation (PWM) or pulse frequency modulation (PFM). In some such embodiments the subsequent switched capacitor converter stage provides a fixed or discrete step-down ratio, for example ½, ⅓ or other ratio. In some embodiments the inductive down conversion stage and the switched capacitor converter together downconvert the input voltage by at least a factor of 4.

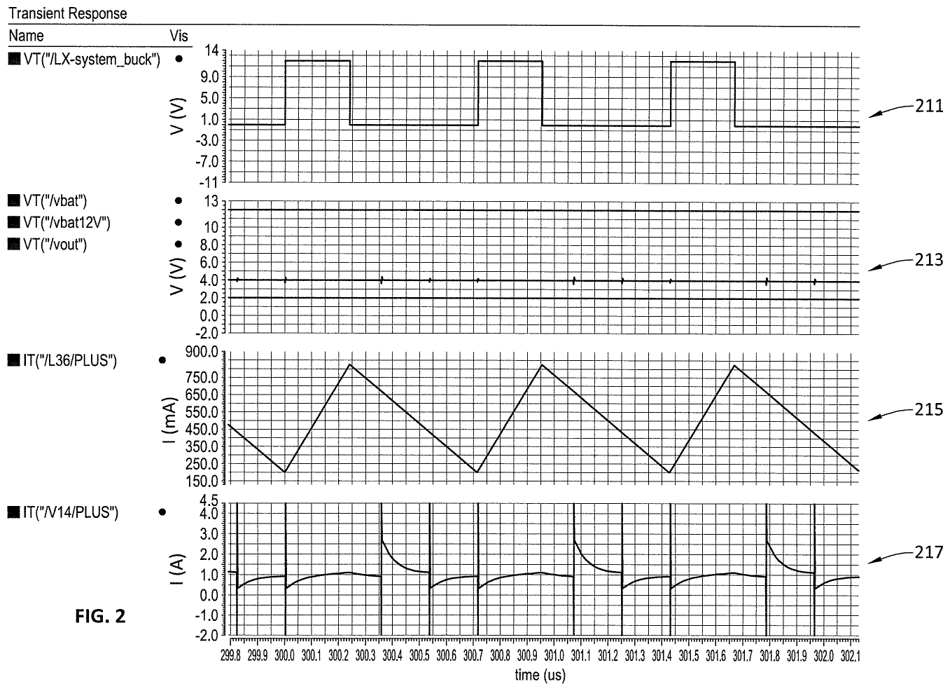

FIG. 2 is a chart illustrating example operation of the voltage regulator of FIG. 1. A first waveform 211 shows system buck power stage control duty cycle. A second set of waveforms 213 shows an input voltage Vin=12V, a voltage output of the inductor stage Vout1=4V, and a switched capacitor converter output voltage V2out=2V. Third and fourth waveforms 215, 217 show simulated inductor (L) current and a switched capacitor converter output load current of approximately 1A. This system demonstrates combined efficiency performance more than 94%. Both systems are switched at 1.4 MHz rate, and it may seen that inductive down conversion stage provides a step-down ratio N of ⅓ while the switched capacitor converter step down conversion ratio M is ½. The voltage regulator, in the example of FIG. 2 therefore achieves an overall step down conversion of ⅙, reducing the input voltage from 12V down to a 2V output voltage.

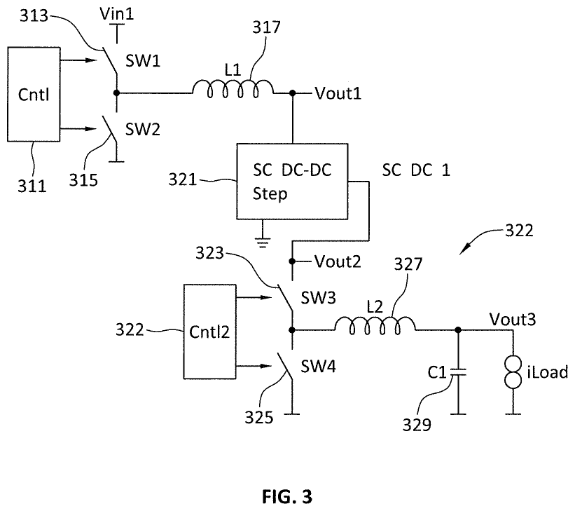

FIG. 3 is a semi-schematic, semi-block diagram including further voltage regulator circuitry in accordance with aspects of the invention. As with the voltage regulator of FIG. 1, a pair of switches, a high side switch 313 and a low side switch 315, are coupled in series between an input voltage and a lower voltage. In many embodiments the input voltage is a supply voltage, for example provided by a battery, and in some embodiments the lower voltage is ground. The switches are controlled by a controller 311, for example as discussed with respect to FIG. 1. A first end of an inductor 317 is coupled between the high side switch and the low side switch. A second end of the inductor is coupled to a DC-DC switched capacitor step down converter 321. The DC-DC switched capacitor step down converter, which again may be simply referred to as a switched capacitor converter, may be as discussed with respect to FIG. 1 or elsewhere herein.

An output from the switched capacitor converter is coupled to a further switched DC-DC converter 322, having the topology of a buck converter. The output from the switched capacitor converter provides an input voltage to the further switched DC-DC converter. The further switched DC-DC converter includes a further high side switch 323 and a further low side switch 325, are coupled in series between the input voltage provided by the switched capacitor converter and a lower voltage. In some embodiments the lower voltage is ground. A first end of a further inductor 327 is coupled to a node between the further high side switch and the further low side switch. A second end of the further inductor is coupled to ground by way of an output capacitor 329. A node between the second end of the further inductor and the output capacitor provides output power to a load. The switches are controlled by a further controller 322 (the functions of which may be included in the controller 311), for example in PWM mode and/or PFM mode so as to obtain a desired output voltage to the load.

The further voltage regulator circuitry therefore provides a first inductive down conversion stage, a second switch capacitor down conversion stage, and a third inductive down conversion stage.

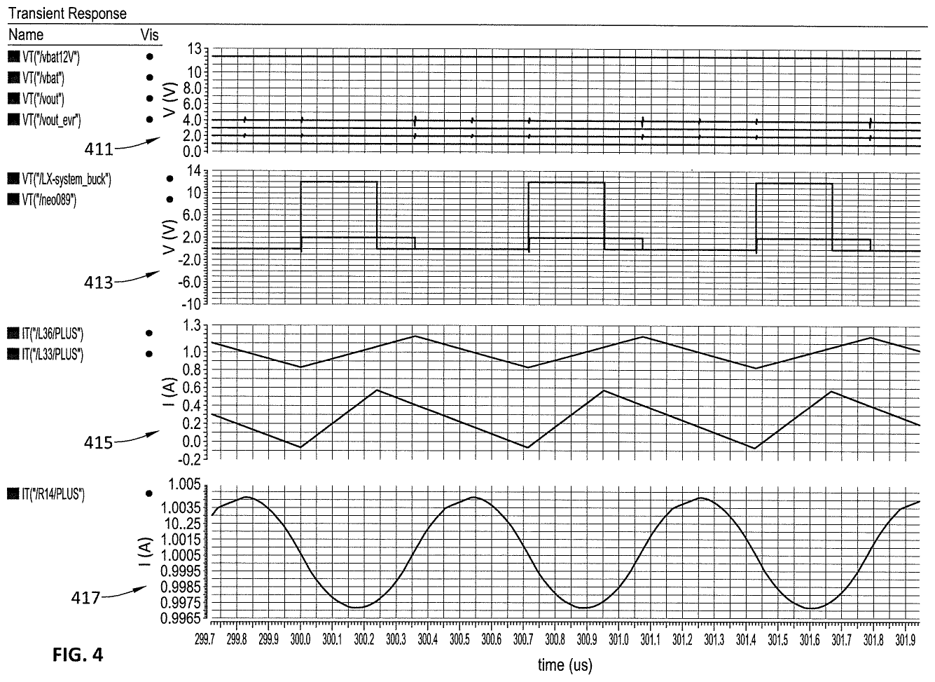

FIG. 4 is a chart illustrating operation of the voltage regulator of FIG. 3. A first set of waveforms 411 show an input voltage of 12V, a first stage output voltage of 4V, a second stage output of 2V, and an output voltage of 1V. A second set of waveforms 413 show buck control signals for the switches of the first stage and switches of the third stage, with a 50% duty cycle for switches of the third stage. A third set of waveforms 415 show inductor currents for the inductors of the first and third stages, and a fourth waveform 417 shows load current.

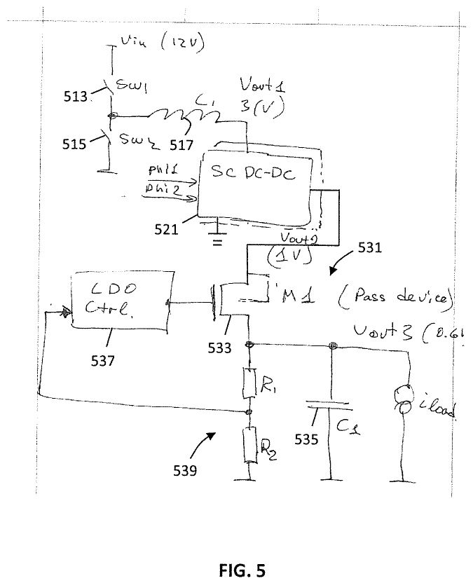

FIG. 5 is a semi-schematic, semi-block diagram including a still further voltage regulator circuitry in accordance with aspects of the invention. The still further voltage regulator circuitry of FIG. 5 is similar to that of FIG. 3, except the third stage of the circuitry of FIG. 5 is an LDO converter, instead of a buck converter as in FIG. 3.

As with the voltage regulator of FIG. 3, a pair of switches, a high side switch 513 and a low side switch 515, are coupled in series between an input voltage and a lower voltage. In many embodiments the input voltage is a supply voltage, for example provided by a battery, and in some embodiments the lower voltage is ground. The switches are controlled by a controller (not shown in FIG. 5), for example as discussed with respect to FIG. 1. A first end of an inductor 517 is coupled between the high side switch and the low side switch. A second end of the inductor is coupled to a DC-DC switched capacitor step down converter 521. The DC-DC switched capacitor step down converter, which again may be simply referred to as a switched capacitor converter, may be as discussed with respect to FIG. 1 or elsewhere herein.

An output from the switched capacitor converter is coupled to an LDO converter 531. The output from the switched capacitor converter provides an input voltage to the LDO converter. The LDO converter of FIG. 5 includes a transistor 533, for example a power FET, with its drain terminal receiving the output of the switched capacitor converter. The drain terminal provides the regulated output to the load, with a filter capacitor 535 in parallel to the load. Control of the FET is provided by a LDO control block 537. The LDO control block receives an input from a voltage divider 539, coupled to the regulated output. The LDO control block may compare the voltage from the voltage divider, or a scaled version of that voltage, with for example a bandgap reference voltage. The LDO regulator may be either on-chip with the other regulator stages and/or SOC, or off-chip.

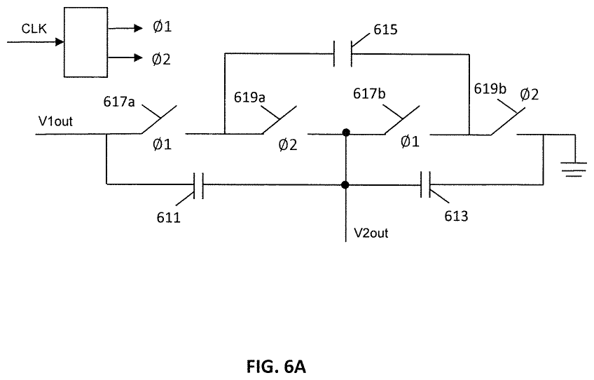

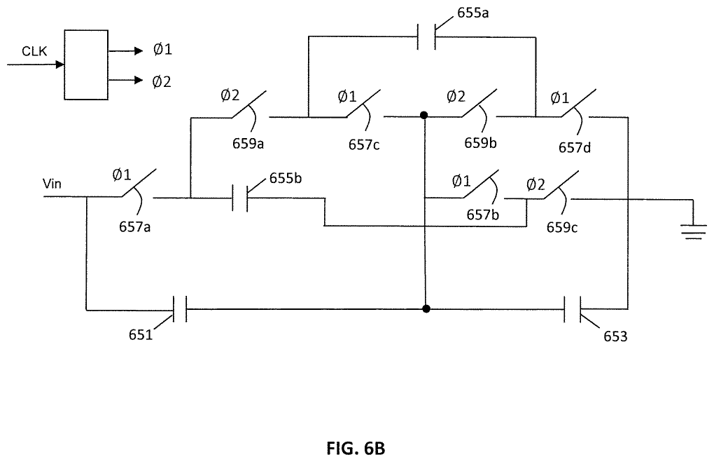

FIG. 6A is a semi-schematic of an example multi-phase switched capacitor converter in accordance with some aspects of the invention. The example switched capacitor converter of FIG. 6A is a single instantiation of a multiphase switched capacitor converter that steps down an input voltage by ½. In various embodiments the switched capacitor converter may step down the input voltage by other ratios, utilizing differing numbers and/or topologies of capacitors. In some embodiments the switched capacitor converter of FIG. 6A, or similar switched capacitor converters, may be utilized in the voltage regulators of FIGS. 1, 3, and 5.

The switched capacitor converter of FIG. 6A makes use of clock signals at a same frequency, but differing phases φ1 and φ2. In some embodiments the differing phases are 180 degrees out of phase, but in various embodiments the phase difference between the signals may be a non-zero degree difference other than 180 degrees, but in such cases additional circuit logic may be present to ensure that only a single set of switches (discussed below) are closed at any instant of time.

A voltage input signal V1out is provided as an input to the switched capacitor converter. The voltage input signal may be, for example, a signal provided as an output of an inductive stage of the voltage regulators of FIG. 1, 3, or 5. The input is provided to capacitors 611 and 613 arranged in series between the input and ground (or some other lower voltage level, for example as discussed with respect to FIG. 1). An output, labeled V2out, of the switched capacitor converter is taken from a node between capacitors 611 and 613.

A flyback capacitor 615 is alternatively coupled either between the input and the output or between the output and ground by a first set of switches 617a,b and a second set of switches 619a,b. The switch 617a selectively couples a first side of the flyback capacitor to the input, and the switch 617b selectively couples a second side of the flyback capacitor to the output. Both switches 617a,b are open or closed at the same time, for example when the signal φ1 is high. Similarly, the switch 619a selectively couples the first side of the flyback capacitor to the output, and the switch 619b selectively couples the second side of the flyback capacitor to ground. Both switches 619a,b are open or closed at the same time, for example when the signal φ2 is high.

Accordingly, in operation the flyback capacitor is alternately coupled between the input and the output, and between the output and ground.

FIG. 6B is a semi-schematic of a further example multi-phase switched capacitor converter in accordance with some aspects of the invention. The example switched capacitor converter is a single instantiation of a multiphase switched capacitor converter that steps down an input voltage by ⅓. In some embodiments the switched capacitor converter of FIG. 6B, or similar switched capacitor converters, may be utilized in the voltage regulators of FIGS. 1, 3, and 5.

As with the switched capacitor converter of FIG. 6, the switched capacitor converter of FIG. 6B makes use of clock signals at a same frequency, but differing phases φ1 and φ2, generally 180 degrees out of phase. A voltage input signal is provided as an input to the switched capacitor converter, for example a signal provided as an output of an inductive stage of the voltage regulators of FIG. 1, 3, or 5. Similar to the switched capacitor converter of FIG. 6A, the input is provided to capacitors 651 and 653 arranged in series between the input and ground (or some other lower voltage level, for example as discussed with respect to FIG. 1). An output of the switched capacitor converter is taken from a node between capacitors 651 and 653.

Flyback capacitors 655a,b are alternatively coupled in parallel with the capacitors 651, 653 or in series between the output and ground by either between the input and the output or between the output and ground by closing either a first set of switches 657a,b,c,d or a second set of switches 659a,b,c, respectively. The first set of switches are open or closed at the same time, for example when the signal φ1 is high. Similarly, the second set of switches are open or closed at the same time, for example when the signal φ2 is high.

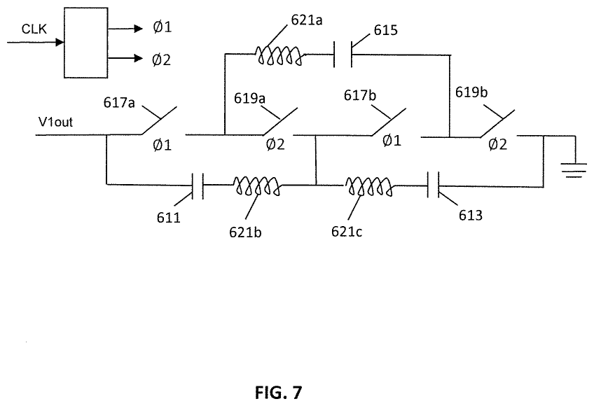

In some embodiments, however, inductances associated with various of the capacitors is utilized to provide for adiabatic power conversion by the switched capacitor converter. FIG. 7 is a semi-schematic of an example multi-phase switched capacitor converter illustrating inductances associated with each of the capacitors in accordance with some aspects of the invention. The switched capacitor of FIG. 7 is the same as that of FIG. 6A, except inductances 621a-c are associated and in series with capacitors 615, 611, and 613, respectively. For simplicity of the figure, the inductances are shown to only one side of each of the capacitors. In general, however, the inductances provide inductance between the switches and the capacitors.

In some embodiments the inductances are parasitic inductances associated with the capacitors, and/or the signal lines between switches of the converter and the capacitors. For example, in some embodiments the parasitic inductances may be in addition or instead associated with a printed circuit board, a semiconductor package, and/or traces or vias within such structures or a semiconductor device. In general, the inductances briefly store energy as magnetic flux during and about time of switching operations, allowing for reduced power losses during capacitor charging. In some embodiments discrete inductors may also be used, particularly those embodiments in which there are larger voltage differences between capacitors. In some embodiments the discrete inductors may have inductances of one or a few nano-Henries.

In one embodiment of this invention the effective series inductance (ESL) of a capacitance based on its structure which is typically between 80 pH to several hundred pico-Henries is considered in the design stage of SC DCDC in terms of the amount of charge that can be transferred during switching without non-adiabatic loss.

In some embodiments inductances to be used, and/or capacitors to be used, is based on voltage differences before and after switching, the amount of charge stored on the capacitor that would be changed by this voltage difference, and using an effective series inductance with high enough impedance to absorb this energy during switching. In many embodiments, the effective series inductance of capacitors used with switched capacitor converters may be between 80 pH to several hundred pico-Henries, and if greater inductance is desired to maintain adiabatic operation then discrete inductors may be added. In some embodiments differences in the amount of charge to be stored on a particular capacitor may be reduced, for example through use of first switching times such that charging and discharging amounts are reduced, use of capacitors in a voltage ladder-like configuration, charging of the capacitor to multiple discreet voltage levels, or through use of other methods. Accordingly, in various embodiments adiabatic current mode and/or adiabatic voltage mode charging may be used. In various embodiments energy losses due to purely resistive elements in the circuits may still be present and proportional to the inductor current IL\hat{ }2*R, but losses due to ½*C*(DeltaV)\hat{ }2 may be eliminated, or significantly reduced. As an example, a voltage difference of 1 mV across 1 uF capacitor requires 1 nC charge. During switching 1 mV may appear across the inductance. Assuming a 100 pH inductor, the initial rate of current increase is 1 mA/100 ns which preferably is stored as magnetic flux in the inductance. As the charge is transferred, the voltage difference decreases, as well as the corresponding magnetic flux of the inductor. For a switched capacitor converter with 1 uF capacitors, each having at least 50 pH effective series inductance, operating at 10 MHz (100 ns switching periods), maximum current across the inductor into the capacitance is proportional to 1 mA per 1 mV voltage difference, and the I\hat{ }2R losses are negligible.

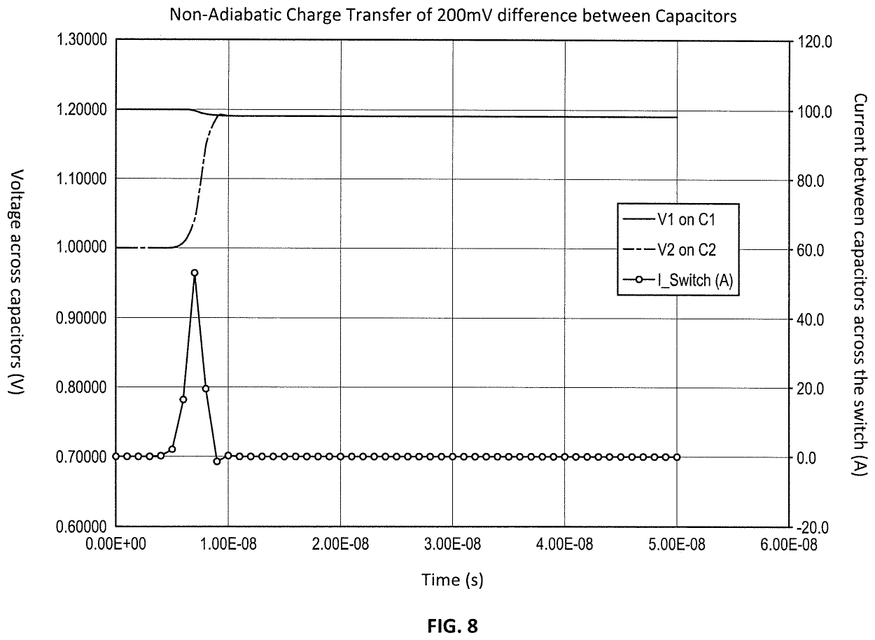

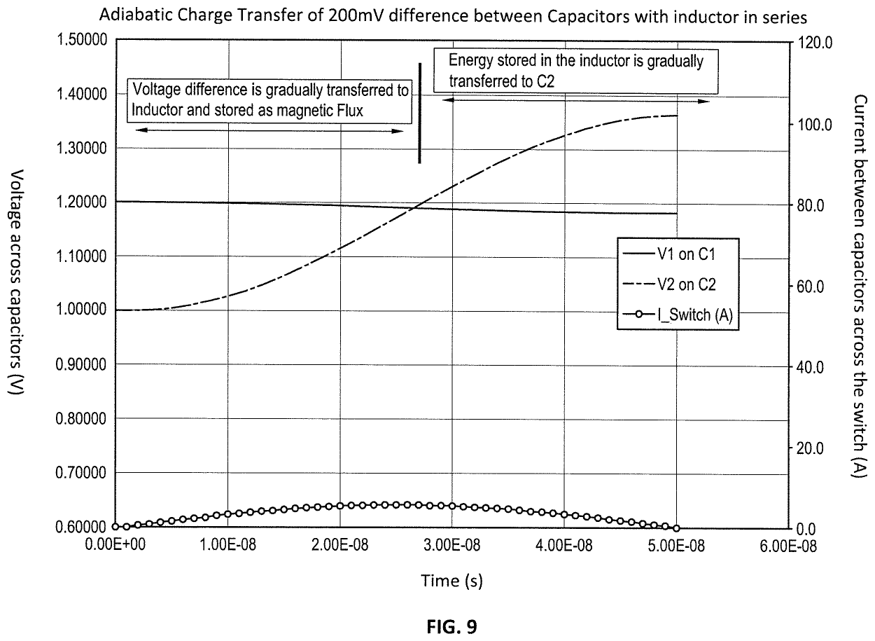

FIG. 8 is a graph illustrating non-adiabatic charge transfer between capacitors of a switched capacitor converter, for example the switched capacitor converter of FIG. 6. FIG. 9 is a similar graph illustrating adiabatic charge transfer between capacitors of a switched capacitor converter utilizing series inductance, for example the switched capacitor converter of FIG. 7. As may be seen in FIG. 8, with non-adiabatic charge transfer current through a closed switch between capacitors quickly ramps up to a relatively sharp peak, and voltage on the charging capacitor quickly climbs. By contrast, as shown in FIG. 9, the effective series inductance slows a ramp rate of current through the switch, with the voltage difference between capacitors gradually first stored as magnetic flux by the inductance and then gradually transferred to the charging capacitor.

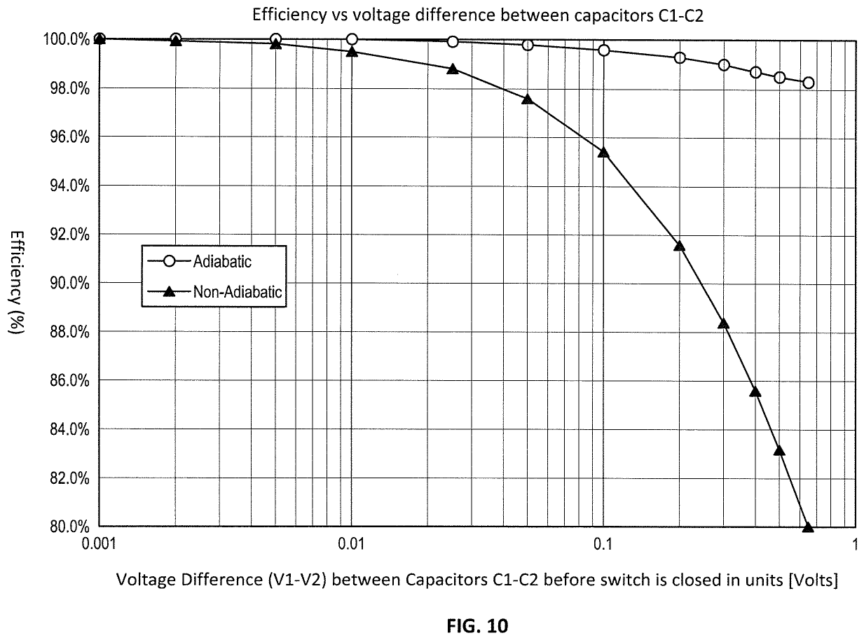

FIG. 10 is a graph showing increases in efficiency between adiabatic operation and non-adiabatic operation for different voltage differences between capacitors. The graph of FIG. 10 shows a range of voltage differences between 0.001V and 1V, on a logarithmic scale, and a range of efficiencies between 80% and 100%. For very small voltage differences, non-adiabatic operational efficiency approaches that of adiabatic operational efficiency. However, with increasing voltage differences between the capacitors, non-adiabatic operation increasingly becomes less efficient than adiabatic operation.

Although the invention has been discussed with respect to various embodiments, it should be recognized that the invention comprises the novel and non-obvious claims supported by this disclosure.

What is claimed is:

1. A DC-DC converter, comprising:
a high side switch and a low side switch coupled in series between an input voltage and a lower voltage; and
an LC filter coupled to a node between the high side switch and the low side switch, the LC filter comprising an inductor and a capacitance, with a first end of the inductor coupled to the node between the high side switch and the low side switch and a second end of the inductor coupled to the capacitance, the capacitance essentially consisting a switched capacitor converter.

2. The DC-DC converter of claim 1, wherein the switched capacitor converter comprises a multi-phase switched capacitor converter.

3. The DC-DC converter of claim 2, wherein the multi-phase switched capacitor converter comprises multiple instantiations of a switched capacitor converter.

4. The DC-DC converter of claim 1, wherein the switched capacitor converter has at least one capacitor coupled at all times between an output to a load and a lower voltage node.

5. The DC-DC converter of claim 1, wherein the switched capacitor converter includes discrete inductors coupled in series between at least some capacitors of the switched capacitor converter.

6. The DC-DC converter of claim 1, further comprising a further high side switch and further low side switch coupled in series between an output of the switched capacitance converter and the lower voltage, a further inductor having a first end coupled to a node between the further high side switch and the further low side switch, and a further capacitor coupled to a second end of the further inductor in parallel to a load.

7. The DC-DC converter of claim 1, further comprising a linear dropout (LDO) regulator coupled between an output of the switched capacitor converter and a load.

8. The DC-DC converter of claim 1, wherein the switched capacitor converter provides a fixed step-down ratio of voltage input to the switched capacitor converter and voltage output from the switched capacitor converter.

9. The DC-DC converter of claim 8, wherein the high side switch, the low side switch, and the inductor provide an inductive down conversion stage, and the inductive down conversion stage and the switched capacitor converter together downconvert the input voltage by at least a factor of 4.

10. The DC-DC converter of claim 1, wherein the switched capacitor converter includes inductances allowing for adiabatic power conversion by the switched capacitor converter.

11. A DC-DC converter, comprising:
an inductive power conversion stage comprising a high side switch and a low side switch, coupled in series between an input voltage and a lower voltage, and an inductor having a first end coupled to a node between the high side switch and the low side switch;
a switched capacitor converter coupled between a second end of the inductor and the lower voltage, the switched capacitor converter comprising a plurality of capacitor and a plurality of switches, the switches operable to have the switched capacitor converter downconvert a voltage provided at the second end of the inductor by a fixed ratio, the switched capacitor converter including sufficient inductances to allow for transfer of charge during switching without non-adiabatic loss.

12. The DC-DC converter of claim 11, wherein the inductances of the switched capacitor converter comprise discrete inductances.

13. The DC-DC converter of claim 11, wherein the inductances of the switched capacitor converter comprise effective series inductances (ESLs).
